(19) United States
(12) Patent Application Publication
(10) Pub. No.: US 2005/0197846 A1
(43) Pub. Date: Sep. 8, 2005

(54) Method and system for generating a proximity index in a social networking environment

(76) Inventors: Peter Pezaris, Delray Beach, FL (US); Michael Gersh, Delray Beach, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/793,242

(22) Filed: Mar. 4, 2004

(51) Int. Cl. G06F 17/60

(52) U.S. Cl. 705/1; 705/10

(57) ABSTRACT

Methods and systems for generating and using proximity thresholds in a social networking environment are disclosed. A first user defines relationships with a plurality of second users by assigning a relationship designator for each connection of a relationship. The first user stores content within the social networking environment and denotes individuals allowed to or prevented from accessing the content by entering one or more proximity thresholds. The social networking environment may generate a proximity index based on a variety of factors. The proximity index may be assigned a particular proximity index grouping depending upon a range in which a proximity index lies. The first user may control access to content and/or allow or prevent the reception and/or display of content from other users based on the other users' proximity index or proximity index grouping with respect to the first user. The user may further order a contact list based on proximity thresholds.

### TECHNICAL FIELD

The present invention generally relates to methods and systems for creating social networking environments. Specifically, the present invention relates to generating a proximity index used to determine the strength of a relationship between two users in a social networking environment based on user-defined and system-generated parameters.

### BACKGROUND

Individuals form social networks of other individuals for a variety of reasons. Most people develop personal networks that include friends, acquaintances, and the like as a means of obtaining social interaction. In addition, people develop professional networks that include co-workers, managers, vendors, clients and the like as a means of enhancing their professional life. A person may use his personal or professional networks (individually or collectively, a person's social network) to, for example, obtain dates, enhance job searches or form a guest list for an event.

A person may attempt to expand his social network by attending social functions or conferences in order to meet new people, by requesting that someone within the person's social network introduce the person to someone outside of the person's social network, or by simply meeting someone on the street. Generally, such expansions of a person's social network require that the two people physically come in contact or at least that the two coordinate to engage in conversation at the same time. Hence, such social network expansion may be time-intensive and require substantive effort on the part of the person seeking to expand his social network.

The introduction of the Internet has provided an additional medium for expanding one's social network. Chat rooms, message boards, and interactive Web sites each provide the opportunity for people to meet other people and expand their social networks. Moreover, information may be transmitted from one person to another over the Internet by posting the information on a Web site or by sending an e-mail message to another person's e-mail address. Because the Internet allows users to interact with individuals that are remotely located, the Internet can provide a powerful tool in expanding one's social network.

In addition, Internet users need not be online at the same time in order to share information or develop a personal contact. For example, one user may send an e-mail message to a second user while the second user is not present at his computer. Despite being remotely located and not being online at the same time, the information may still be transmitted to the second individual.

Accordingly, computers and the Internet have increasingly become tools that allow people to interact with one another and to meet new people. E-dating Web sites, social networking Web sites, which are either social or professional in nature, and other similar services have been developed to meet this need.

One problem with these services is that information is generally made publicly available to either an unspecified or a restricted number of people. For example, if an individual posts a message regarding an event on a Web site that is publicly available, anyone accessing the Web site may learn of the event, even if the organizer did not intend to invite everyone with access to the Web site.

Conversely, the individual may send an e-mail regarding the event to a distribution list. However, if the organizer intends to permit people who are unknown to the organizer but are acquainted with those on the distribution list to attend, those initially receiving the message must forward the information. As such, proper dispersal of information to all invited parties is dependent upon the recipients of the message and may not occur for a variety of reasons.

Social networking Web sites have been developed to provide some control over the distribution of content within a social network. A user may enter the names of one or more individuals into the social networking Web site. The site may generate a connection between the user and each individual immediately or may wait until a response has been received from an individual before creating a connection between the user and the responding individual.

Conventional social networking Web sites have addressed the issue of access control by defining relationships to be in tiers. For example, all people directly connected to a particular user are said to be in the user's first tier. The second tier is composed of all users that are first tier connections to individuals who are in the user's first tier, and so on. In theory, no more than six tiers would separate each user from any other user if the network included a substantial subset of the people in the world.

One problem with conventional social networking Web sites is that the tier method of access control may simultaneously be overly inclusive and exclusive. For example, if a user desires to send information to a subset of individuals in the user's first tier and a subset of individuals in the user's second tier, sending the information only to the first tier would prevent the individuals in the user's second tier from receiving the information. Moreover, too many individuals in the user's first tier would receive the information. Accordingly, using the tier system alone does not provide adequate access control in a social networking environment in at least circumstances similar to the one described.

Another problem with conventional social networking Web sites is that a user's contacts are merely listed in tiers. For example, a social networking Web site typically lists all of the contacts of a user in one grouping. Contacts of a user's contacts may be listed in a separate grouping, and so on. However, no quantitative or qualitative assessment of the strength of the relationship between a user and other users is performed in creating these groupings. Accordingly, a user might have to spend an excessive amount of time searching for a close contact in a user contact list.

What is needed is a method and system for appropriately controlling access to user information in a social networking environment.

A need exists for a method and system for controlling access to user information in a social networking environment by using proximity parameters generated by the social networking environment.

A further need exists for a method and system for quantitatively or qualitatively assessing the strength of a relationship between two users.

A still further need exists for displaying a user's social network in a social networking environment ordered by a quantitative or qualitative assessment of the strength of the relationships between the user and the user's contacts.

The present invention is directed towards solving one or more of these problems.

### SUMMARY OF THE INVENTION

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “proximity threshold” is a reference to one or more proximity thresholds and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method of generating a proximity index in a social networking environment includes determining one or more connections for a relationship between a first user of a social networking environment and a second user of the social networking environment, determining a relationship strength for at least one of the one or more connections based on at least one relationship designator, and determining a proximity index based on the one or more relationship strengths. The proximity index may include a numerical value. Determining a relationship strength may be based on at least a number of tiers between the first user and the second user, a relationship designator type, the number of connections between the first user and the second user, one or more shared memberships, a number of members in a shared membership, determining whether a shared membership is public or private, one or more communications between the first user and a second user, one or more first communications between the first user and a third user and one or more second communications between the second user and a third user, and/or one or more communications between a third user and a fourth user. Each of the above listed communications may occur within the social networking environment.

In an embodiment, the method may further include selecting a proximity index grouping for the relationship from one or more proximity index groupings based on the proximity index. Each proximity index grouping may include relationships within a range of proximity indices. In an embodiment, the method may further include one or more of permitting the second user to access content of the first user if the proximity index grouping for the second user's relationship with the first user corresponds to an access control value set by the first user, preventing the second user from accessing content of the first user if the proximity index grouping for the second user's relationship with the first user does not correspond to an access control value set by the first user, permitting the first user to access content directed to the first user by the second user if the proximity index grouping for the second user's relationship with the first user corresponds to an access control value set by the first user, and preventing the first user from accessing content directed to the first user by the second user if the proximity index grouping for the second user's relationship with the first user does not correspond to an access control value set by the first user.

In an embodiment, the method may further include one or more of permitting the second user to access content of the first user if the proximity index for the second user's relationship with the first user corresponds to an access control value set by the first user, preventing the second user from accessing content of the first user if the proximity index for the second user's relationship with the first user does not correspond to an access control value set by the first user, permitting the first user to access content directed to the first user by the second user if the proximity index for the second user's relationship with the first user corresponds to an access control value set by the first user, and preventing the first user from accessing content directed to the first user by the second user if the proximity index for the second user's relationship with the first user does not correspond to an access control value set by the first user.

In an embodiment, a method of ordering a contact list in a social networking environment includes determining one or more proximity indices that are each based on a strength of a relationship between a first user of a social networking environment and a second user of the social networking environment, and ordering a social network for the first user based on the one or more proximity indices. The social network for the first user includes one or more second users. The social network for the first user may only include second users having a proximity index exceeding a threshold. The method may further include displaying the ordered social network.

In an embodiment, a method of ordering a contact list in a social networking environment includes determining one or more proximity indices that are each based on a strength of a relationship between a first user of a social networking environment and one of a plurality of second users of the social networking environment, determining a range of proximity indices for each of one or more proximity index groupings, classifying each second user into at least one of one or more groups, and ordering a social network for the first user based on the groups. Each group represents second users having a particular proximity index grouping. The social network for the first user includes one or more second users. The social network for the first user may include second users within one or more groups. The method may further include displaying the ordered social network. Displaying the ordered social network may include, for each group, displaying second users within the group alphabetically.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIG. 1 depicts an exemplary screen shot for adding a user contact according to an embodiment of the present invention.

FIG. 2 depicts an exemplary screen shot for setting access control using a proximity index according to an embodiment of the present invention.

FIG. 3 depicts an exemplary screen shot for a marketplace item listing using a proximity index to control access to the item according to an embodiment of the present invention.

FIG. 4 depicts an exemplary screen shot for a people search screen using a proximity index according to an embodiment of the present invention.

FIG. 5 depicts an exemplary screen shot for a content list using a proximity index according to an embodiment of the present invention.

FIG. 6 depicts an exemplary screen shot for a market item list using a proximity index according to an embodiment of the present invention.

FIG. 7 is a block diagram of exemplary internal hardware that may be used to contain or implement the program instructions of a system embodiment of the present invention.

### DETAILED DESCRIPTION

The present invention generally relates to methods and systems for creating social networking environments. Specifically, the present invention relates to generating a proximity index used to determine the strength of a relationship between two users in a social networking environment based on user-defined and system-generated parameters.

A relationship is a set of one or more connections between a first user and a second user. Each connection is a particular path connecting the first user and the second user within a social networking environment. A connection is either direct (i.e., no intervening users between the first user and the second user) or indirect (i.e., at least one intervening user between the first user and the second user). Each connection includes one or more direct connections (also known as “steps”). Each step in the present invention includes a relationship designator (defined below). A tier is the set of users who are an equal number of steps away from a particular user. Thus, a first user's second tier includes all users who are two steps away from the first user.

In an embodiment, a user assigns one or more relationship designators to define one or more connections between the user and a contact. A social networking environment may use additional or alternate user-defined and/or system-generated parameters to define connections between two users. In an embodiment, the social networking environment may generate a proximity index to define the strength of the relationship between two users based on such parameters.

Relationship Designators

User defined parameters for access control in a social networking environment may include at least one relationship designator defining a connection between an individual and a contact (i.e., a first tier individual in conventional social networking environments). Relationship designators may include one or more of familial relationship designators, friendship relationship designators, co-worker relationship designators and business associate relationship designators. Familial relationship designators may include wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner. Friendship relationship designators may include fiancé, girlfriend, boyfriend, friend, roommate, neighbor, sorority sister, fraternity brother and classmate. Co-worker relationship designators may include co-worker, manager, employee and business partner. Business associate relationship designators may include vendor, supplier, client, contractor and business contact. In an embodiment, additional or alternate relationship designators may be used for a social networking environment. In an embodiment, alternate or additional categories of relationship designators may be used. In an embodiment, relationship designators may be grouped in different categories.

In an embodiment, a relationship between two individuals may include more than one connection. For example, a user may be each of a friend, a fraternity brother, a classmate and a business partner of another user. In such an embodiment, the present invention may permit a user to enter a plurality of connections to appropriately describe the relationship between the user and an individual. The social networking environment may require the individual to separately confirm each connection in order to describe the relationship between the user and the individual accurately.

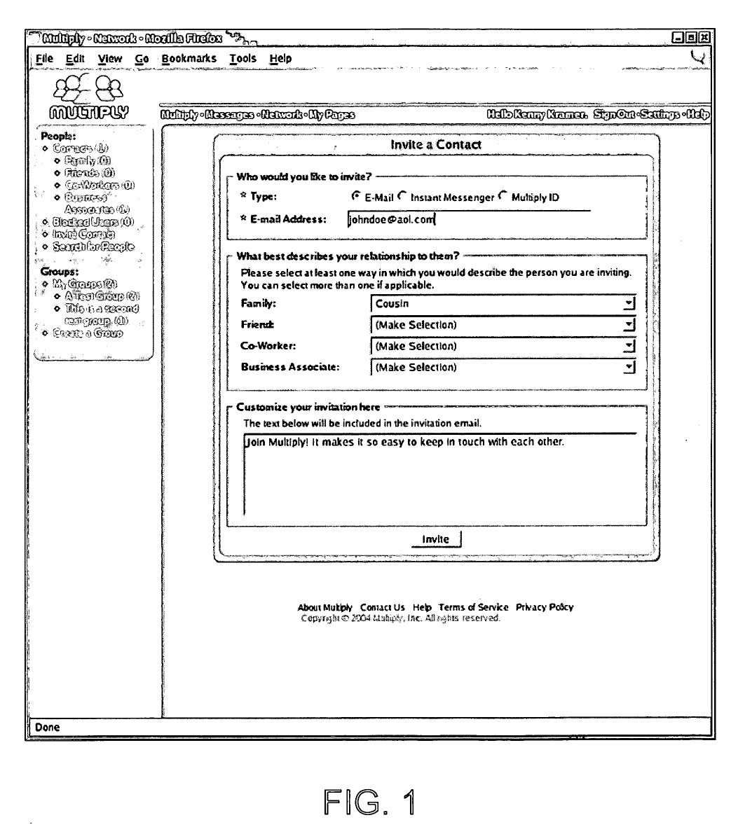

In an embodiment, the user assigns one or more relationship designators to an individual when the individual is added as a contact. An exemplary screen shot for adding a contact according to an embodiment of the present invention is shown in FIG. 1. The relationship designators assigned upon acceptance of the invitation to become a contact may be used to determine a proximity index between the user and the individual.

The individual may receive a message from the social networking environment stating that the user would like to add the individual as a contact. In an embodiment, the social networking environment may automatically assign a second relationship designator based upon the first relationship designator assigned by the user to the individual and the genders of each of the user and the individual. For example, a male user may assign a relationship designator of “girlfriend” to a female contact. Upon acceptance of the contact relationship by the female contact, the social networking environment may automatically assign a relationship designator of “boyfriend” to the male user in the female contact's social network. In an embodiment, the social networking environment automatically assigns corresponding relationship designators for a subset of all relationship designator types, such as familial relationships. In an embodiment, the social networking environment may permit an individual to assign his or her own relationship designators to a contacting user when accepting an invitation to form a relationship or after such acceptance.

In the case where the individual to which the user assigns one or more relationship designators is not a user of the social networking environment, the individual may be required to become a user before the individual is added as a contact of the first user. In the case where the individual is already a user of the social networking environment, the environment may relate the user to the individual upon receipt of the individual's affirmative response to the user's request.

A relationship designator may be combined with a tier designator (described below) to denote a relationship within a social networking environment. For example, the user may state that content is available to all “second tier friends.” In an embodiment, the designation “second tier friends” may make content available to the friends of each of the user's contacts. In an alternate embodiment, the designation “second tier friends” may make content available to friends of each of the user's friends. Additional designations and/or more particular designations may be made using embodiments of the present invention.

Group Designators

User defined parameters for access control in a social networking environment may further include a group designator of which one or more users are members of a group associated with the group designator. In an embodiment, group designators are a subset of relationship designators. A group designator may operate as a user-defined relationship designator.

A user may create a group in a social networking environment, assign a group designator to the group and invite other users to become members of the group. A user that controls the operation of the group is referred to as the “manager.” Other users in the group are referred to herein as “members.” The manager is typically also a member. Users who have been invited to join the group are referred to herein as “pending members.”

In an embodiment, the manager creates the group by, for example, clicking on a link to create a new group and assigning a group name to the group. Assigning the group name may further include assigning a group identifier. Once created, the manager may invite other users to become members of the group. A message may be transmitted to the pending members alerting them that the manager has requested their acceptance of group membership. Pending members may then accept or deny membership in the group. Upon acceptance, members may further invite other users to join the group.

Group members may interact within the social networking environment by sending messages or posting content to other group members. Groups may be created for any purpose. Exemplary groups include, without limitation, scout troops, airplane enthusiasts, fraternity brothers, fans of a musical group and the like.

A user may combine a group designator with a tier designator (described below) to control access to user-specified content within a social networking environment. For example, the user may state that the content is available to “my airplane enthusiast club's family.” In an embodiment, the designation “my airplane enthusiast club's family” may make content available to the family members of each member of the airplane enthusiast club. In an embodiment, the designation may also make content available to each member of the airplane enthusiast's club. Additional designations and/or more particular designations may be made using embodiments of the present invention.

Tier Designators

A tier designator may represent the shortest distance between two individuals. For example, if a first user is a friend of a second user, who is the wife of a third user, who is a co-worker of a fourth user, then the first user is in the third tier of the fourth user's social network. Likewise, the fourth user is in the third tier of the first user's social network. If the first user is additionally the manager of a fifth user, who is a friend of the fourth user, then the first user and the fourth user would each be in the second tier of the other user's social network based on their relationship via the fifth user.

Tier designators may provide one measure used in determining the proximity index. In addition, tier designators may be combined with one or more relationship designators to assist in defining the strength of a relationship between two users. The use of tier designators in combination with relationship designators is described above.

Proximity Index

A social networking environment may determine proximity indices between users of the environment. A proximity index measures the strength of the relationship between two users of the environment.

Proximity indices may permit a user to manage control of his content by appropriately presenting content to the proper audience. Indeed, by properly assigning a proximity index, the user makes the content inherently more valuable. For example, a user may be more interested in purchasing items from a person known to him or known by a friend than from a stranger. Moreover, a review of a restaurant from a newspaper or periodical may be less interesting than a review from someone that a user knows.

In addition, proximity indices may permit the social networking environment to display a user's social network based on a qualitative or quantitative assessment of the strength of relationships between the user and each member of the user's social network. If the strength of a relationship surpasses a proximity threshold, the social networking environment may display the member in a contact list. In an embodiment, a plurality of proximity thresholds may be established, and the members of the user's social network may be organized based on the highest proximity threshold surpassed by the proximity index corresponding to each member.

The strength of the relationship may depend on the type of relationship between the user and a member of the social network. For example, the relationship between a user and the user's brother may be stronger than the relationship between a user and a user's business associate. Accordingly, the proximity index for the relationship between the user and the user's brother may be greater than the proximity index for the relationship between the user and a user's business associate.

The strength of the relationship between a user and a member of the user's social network may also depend upon the number of steps between the user and the member. If more steps exist between the user and the member, the connection between the user and the member is generally more tenuous. For example, the relationship between a user and a user's business associate may be stronger than the relationship between the user and a user's brother's business associate. However, it is not always the case that additional steps make a relationship more tenuous. For example, the relationship between a user and a user's business associate may be weaker than the relationship between the user and the user's brother's wife. Accordingly, simply analyzing tier relationships is not sufficient to determine the proximity index for a relationship because the nature of each connection between two users may be important to determining the proximity index.

The strength of the relationship between a user and a member of the user's social network may also depend on the number of connections between the user and the member. For example, the relationship between a user and a user's friend may be weaker than the relationship between the user and a user's friend who is also the user's business partner. Thus, additional connections between the user and a member may denote that a user has a closer relationship with that member than with a member possessing a subset of the connections.

Moreover, the strength of the relationship between two users may depend upon whether the two users are members of the same group. Two users who are each members of a private group may have a stronger relationship than two users who are members of a public group. Similarly, two users who are each members of a group with relatively few members may have a stronger relationship than two users who are each members of a group with more members.

Furthermore, if two users communicate or communicate frequently, the social networking environment may determine that the two users have a strong relationship. Conversely, if two users do not communicate, the social networking environment may determine that the relationship is weak. Additionally, if shared contacts of the two users communicate or the two users each communicate with a shared contact, the relationship may be deemed stronger.

The social networking environment may consider one or more of these factors in determining a proximity index. The above-listed comparisons and factors are exemplary only. The social networking environment may consider other factors and/or additional factors in determining the proximity index.

A user may use a proximity threshold as a parameter to determine one or more individuals that receive specific content from the user. The user may set proximity thresholds for all content created by the user, all content of a particular type or particular content.

The proximity index may be, for example, a numerical value between 0 and 1, inclusive. In an embodiment, a proximity index of 1 may represent the relationship of a user to himself and may not be achievable between two distinct users.

The social networking environment may map ranges of numerical proximity indices to a proximity index grouping having a user-discernable label. In an embodiment, a proximity index between 0.800 and 0.999 may map to a proximity index grouping having a label of “Very Close;” a proximity index between 0.600 and 0.799 may map to a proximity index grouping having a label of “Close;” and a proximity index between 0.400 and 0.599 may map to a proximity index grouping having a label of “Distant.” In an embodiment, a proximity index grouping containing relationships having a proximity index less than 0.400 may not receive a label because the relationships are too tenuous. The above-listed ranges, groupings and labels are exemplary only. Any ranges, number of groupings and/or grouping labels may be used for the proximity index groupings.

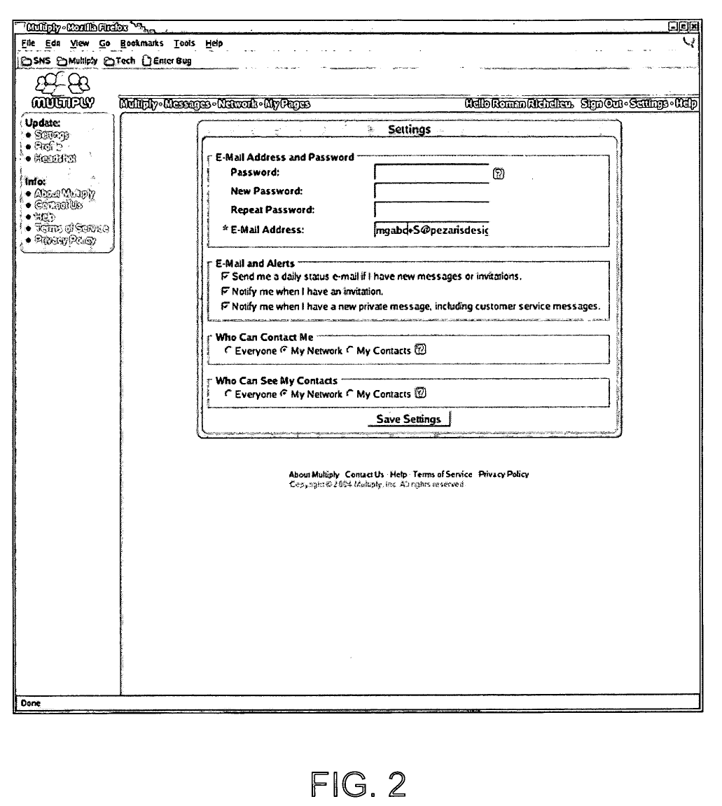

The social networking environment may use icons associated with the proximity indices to enable users to quickly modify settings and identify the proximity between themselves and other users. In an embodiment, an icon pertaining to a proximity index for a content item's sender may be included in each row of a table containing messages or items for sale in a marketplace. In an embodiment, a user may elect to filter his messages based on the proximity of the sender to the user. Thus, a user may only view messages from people in the user's social network who are “Very Close” or “Close.” In an embodiment, a user may only display contacts based on the proximity of the user to each contact. For example, the user may only view contacts who have proximity indices of “Very Close” or “Close” with respect to the user. An example of a settings window for controlling messages displayed to a user is shown in FIG. 2. Moreover, the user may order the contacts based on the proximity indices of the contacts with respect to the user. In an embodiment, if the proximity indices of the contacts with respect to the user are used to order contacts, the social networking environment may classify contacts based on their proximity indices into one or more groups and, optionally, may alphabetically order each group.

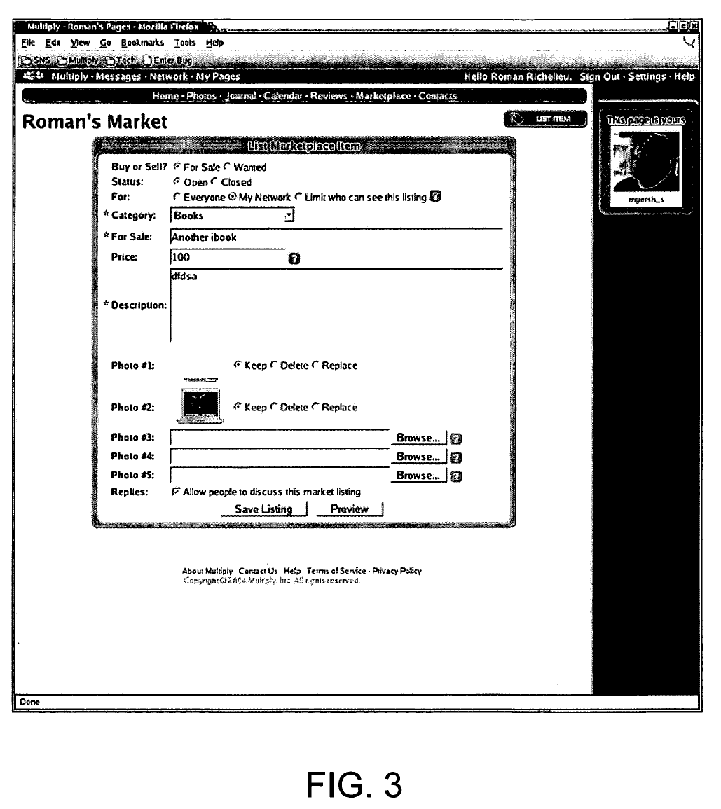

In an embodiment, a first user may select an access control, such as the “My Network” selection shown in FIG. 3, that limits access to second users who are within a first user's social network. In an embodiment, a second user having a proximity index that exceeds a proximity threshold is within the first user's social network. Moreover, access control criteria may be used to only display content to the first user if it is sent from users within the first user's social network. Furthermore, the social networking environment may construct a first user's contact list by displaying only those users within the first user's social network.

People Search

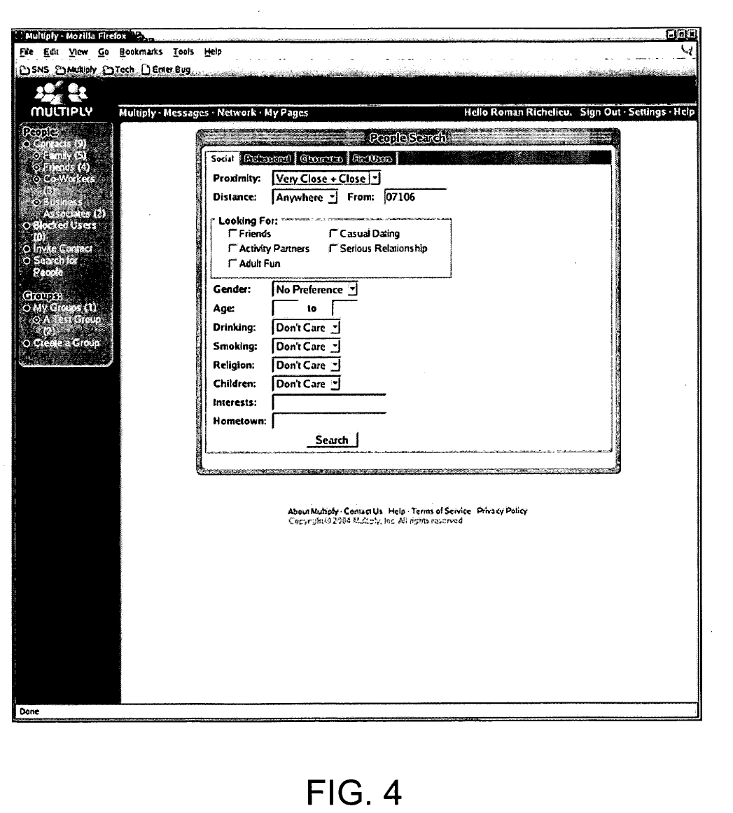

The proximity index may be used to search for individuals within the social networking environment, as depicted in FIG. 4. For example, as shown in FIG. 4, a user may search for all users that are Close or Very Close to the user. The determination of whether another user is Close or Very Close to the user is dependent upon the proximity index between the two users. Alternate proximity thresholds, such as only users who are Very Close or all users in a user's social network, may be used to perform a search as well. In addition, other factors, including without limitation the ones shown in FIG. 4, may be used to further determine the desired scope of a search.

Content Types

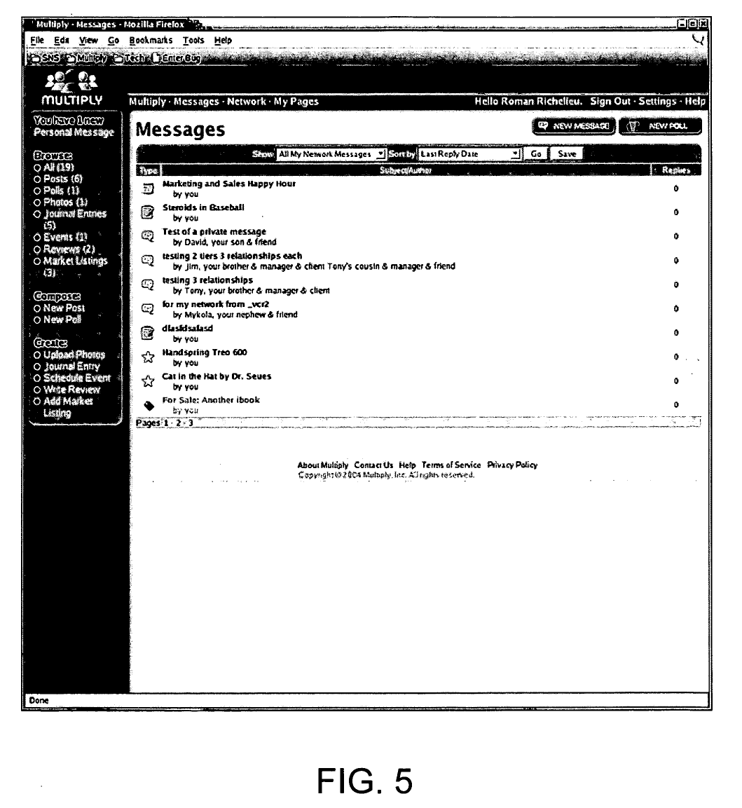

The user may provide access to different types of content. For example, the user may provide access to, personal information, members of the user's social network, photographs, reviews, journals, events, marketplace items, and any other type of content. In addition, the user may restrict items that the user views based on access control designations. An exemplary content list is shown in FIG. 5. Each of the above-listed types of content will be briefly discussed below. Although access control is discussed with respect to each of the above-listed content types, access control may be performed on unlisted content types as well.

Home Page and Personal Information

A user may access home pages within the social networking environment. A home page may correspond to a particular user or group of users (i.e., the owner). The home page may include identifying information for the owner and one or more listings created by the owner organized based on content type.

In an embodiment, a minimal amount of identifying information is displayed to users that are not an owner of the home page. Such information may include, for example, the owner's first name, gender, city, state and zip code. The owner may choose to display additional information on the home page. Such other information may be displayed generally or may be limited to members of the owner's social network having a proximity index greater than a threshold.

The owner may customize his home page to display other information based on, for example, content type. Content types may include, for example, photographs, journals, calendars, reviews, marketplace item listings and other content types. The owner may add snapshot versions of the content areas to the home page. A snapshot version may include a subset of the content included in the full content listing for that content type. The owner may add a snapshot version for one or more of the content types. The owner may also add other content types such as a list of favorite things, a wish list, testimonials, guest books, usage statistics and the like. For each content type, the owner may control access to the content based on the proximity index of the viewer with respect to the owner. In an embodiment, display of a snapshot for a particular content type on the owner's home page is dependent upon the viewer meeting the proximity index threshold (i.e., a “proximity threshold”) that the owner assigns for content of that content type. Proximity thresholds for each content type are described in more detail below.

A user's personal information may be sub-divided into categories. The categories may include, for example, contact information, background information, social information, scholastic information and professional information. In an embodiment, access control may limit the amount of information displayed to other users. Different levels of access control may be applied to each category of information or to each item of information within a category.

In an embodiment, contact information includes, without limitation, the owner's first name, middle name, last name, e-mail address, messenger ID, messenger type (e.g., AOL IM®, ICQ, Windows Messenger®, Yahoo! Messenger®, etc.), street address, city, state, country, zip code, home phone number, work phone number, mobile phone number, fax number and personal Web site.

In an embodiment, the background information includes, without limitation, fields for an owner's gender, date of birth, interests, hometown, photograph, logo and a free-form text section describing any information the owner may wish to add to his profile. In an embodiment, the social information may include, for example, a relationship status (e.g., single, married, divorced, etc.), a “looking for” section, and information pertaining to the type of person the owner is seeking. The “looking for” section may include, for example, friends, activity partners, casual dating, serious relationship, and other categories. The information pertaining to the type of person the owner is seeking may include one or more of gender, age range, drinking habits, smoking habits, religious beliefs, whether the person wants children, a free-form text field, and other fields.

In an embodiment, the scholastic information field includes, without limitation, fields for the name of a school that the owner attended, the type of school, the city where the school is located, the state or province where the school is located, the country where the school is located, the owner's graduation year, the owner's degree or major, and one or more social organizations. The type of school may include, for example, grammar school, junior high school, senior high school, college/university, graduate school, medical school, law school, technical school or other schools. In an embodiment, the social organization field may only be displayed if the owner selects a school type of college/university. The owner may enter information for one or more schools. The information may be displayed in list form on the home page if access is provided to such information.

In an embodiment, the professional information field includes, without limitation, fields for the owner's occupation, position or title, company, company web site, industry, a “looking for” field, an overview of the owner's background, and lists of the owner's skills, previous positions held, past companies, and associations. The owner may further include a resume. The “looking for” field may denote that the owner is looking for a job, consulting or contracting position; employees or consultants; customers for products or services; information about industries, products or companies; or individuals in the owner's industry.

In an embodiment, more, fewer or different fields may be included in each of the basic, background, social, scholastic and professional information categories. In an embodiment, more, fewer or different information categories may be used.

User's Social Network

A user's social network may be sub-divided into people and group categories. The people category may include, for example, subcategories for family, friends, co-workers, business associates and blocked users. Other categories, including fewer or more categories, may be included. Blocked users may include a list of users from which content is blocked or for which access to a user's home page and content is blocked. The group category may include one entry for each group of which the user is a member. A designator may indicate the number of members of a group, the people category or a people sub-category.

For the people category, selecting a people category link may display a list of all individuals listed as contacts for the user. In addition, selecting any of the sub-category links may display a list of all individuals listed as contacts with an appropriate relationship designator for that sub-category. The list of individuals in a sub-category or in the people category may be further sub-divided based on a status for each individual. Potential statuses may include, for example, Unconfirmed, Pending and Confirmed. An Unconfirmed individual may be another user that is waiting for the user to confirm a relationship that the other user has proposed. A Pending individual may be an individual with whom the user has proposed a relationship, but who has not responded to the user's request. A Confirmed individual may be a user who has accepted a relationship proposed by the user or vice-versa. Additional, fewer or alternate status designators may be used. In an embodiment, if no individuals possess a particular status designator, that status designator is not displayed. If no contacts of any status are found for the selected category or sub-category, the social networking environment may display a message encouraging the user to make additional contacts of that type. Each table may list the individuals in that category or sub-category in a table. The table may include information pertaining to each contact including, without limitation, the contact's name, user ID, relationship, and number of contacts that the individual has. If the contact is unregistered, the name field may display an e-mail address or a messenger ID. The social networking environment may assign a user ID to an individual upon registration. The relationship may include the one or more relationship designators used to identify the relationship between the user and the listed individual. Each element of the table may provide a link to another area of the social networking environment.

The individuals in the Confirmed status section may be organized based on the proximity relationship between the user and each individual. In an embodiment, proximity index groupings may be used to separate individuals that have a relationship with the user. Individuals having a proximity index within a range may be classified into separate proximity index groupings. All members of a user's social network that are Very Close to the user may be listed under a “Very Close” label. In an embodiment, the members may be further ordered based on their proximity indices within each proximity index grouping. In an embodiment, the members may be further ordered alphabetically within each proximity index grouping.

Selecting a user group may display a table listing all of the members of that group. The table may include one or more fields for each group member containing information pertaining to the group member, such as the group member's name, user ID, joining date and status. A group member's status may include, without limitation, pending, member or manager. If the group does not have any members, a message may be displayed relaying that fact.

The individuals in a group may be organized based on the proximity relationship between the user and each individual. In an embodiment, proximity index groupings may be used to separate individuals that have a relationship with the user. Individuals having a proximity index within a range may be classified into separate groupings. All members of a user's social network that are Very Close to the user may be listed under a “Very Close” label. In an embodiment, the members may be further ordered based on their proximity indices within each proximity index grouping. In an embodiment, the members may be further ordered alphabetically within each proximity index grouping.

Photographs

When a first user accesses a second user's photo page within the social networking environment, the first user may be presented with a list of the second user's photo albums. The list of photo albums may not include all photo albums produced by the second user due to a proximity threshold defined by the second user. For example, if the first user has a Distant relationship to the second user, the first user may not be able to access photo albums designated only for users who are Close or Very Close. In an embodiment, if a user accesses his own photo page, photo album or photo, the social networking environment may permit the user to perform additional functions related to managing albums and photos, such as, for example, uploading, editing or deleting photos or photo albums.

In an embodiment, the social networking environment may present the photos in formats including, without limitation, thumbnail and details. In the thumbnail format, cover images for each photo album may be displayed to the user. A cover image may be a small version of an image in the photo album or any other image. The albums may be organized in descending or ascending order of date created or accessed, alphabetical order, any other order or randomly. Multiple cover images may be displayed in each row. A name of the photo album may be displayed with the cover image. For groups in which more than one member of the group can post photos, the name of the user posting the album may also be displayed with the cover image. Selecting a cover image may display the photos in a photo album. The photos may be displayed in a reduced size format to maximize the number of photos displayed.

The details display format may list photo albums ordered by name or any other order in a table. In an embodiment, fields for the table include, without limitation, the album name, a description of the album, the number of photos in the album, the date of creation, and the number of users who have viewed the album. In an embodiment, the last column is only displayed for the owner of the photo album or, in the case of group photo albums, the group manager.

Each photo album may have a set of links associated with it that only an owner of the photo album may access. In an embodiment, these links include edit album, publish album, delete album and upload photo. The edit album link may allow the user to change album properties, such as, for example, the name of the photo album, the cover image of the photo album, a description of the album, a proximity threshold, and an ability to determine whether viewers may comment on the photo album. A proximity threshold may be set, for example, by accessing a checklist or a pulldown menu to determine the relationship strength required to access a photo or a photo album.

The publish album link may generate a notification message to all users having access to the photo album and create a thread associated with the photo album. An owner of the photo album and, if permitted by the owner, other users having access to the photos may post comments pertaining to the photos in the photo album in the thread. The delete album link may enable an owner to delete a photo album and its associated thread.

The upload photo link may permit owners to associate photos with a photo album. In an embodiment, group members may be allowed to upload photos if permitted by the group manager. The group manager may determine members that may upload photos based on setting a proximity threshold as described above.

Reviews

When a first user accesses a second user's review page within the social networking environment, the first user may be presented with a list of the second user's reviews. The list of reviews may not include all reviews created by the second user due to a proximity threshold defined by the second user. For example, if the first user has a Distant relationship with the second user, the first user may not be able to access reviews designated only for users who are Close or Very Close. In an embodiment, if a user accesses his review page or a specific review, the social networking environment may permit the user to perform additional functions related to managing reviews, such as, for example, editing or deleting the reviews.

Reviews may be displayed, for example, in chronological or alphabetical order. In an embodiment, the category for the review, the title of the review, the rating assigned to the reviewed item and the date that the review was posted, for example, may be displayed for each review. In an embodiment, the user selects a review category from a checklist or a dropdown menu. In an alternate embodiment, the user enters a review category in a text box. Review categories may include, for example, movies, books, restaurants, products, music, games and the like. If the reviewer permits comments to be added to reviews, a designation of the number of comments and a link permitting a viewer to add comments to a review, for example, may be associated with the review.

In an embodiment, each review has one or more links associated with it that the reviewer can access. In such an embodiment, only the reviewer may have access to these links. The links may include a link to edit a review and a link to delete a review.

The edit review link may include one or more input fields, such as the category for the review, the name of the item being reviewed, the artist, genre, cuisine, product type, author, street address, city, state, country, zip code, manufacturer, console, the details of the view the rating and a proximity threshold. One or more of the above listed input fields may not be available based on the category selected by the reviewer. A proximity threshold may be set, for example, by accessing a checklist or a pulldown menu to determine the relationship strength required to view the review. Once the review is complete, the owner may post the review. The delete review link may remove the review from the social networking environment.

Journals

When a first user accesses a second user's journal page within the social networking environment, the first user may be presented with entries in the second user's journals. The list of journal entries may not include all journal entries produced by the second user due to a proximity threshold defined by the second user. For example, if the first user has a Distant relationship with the second user, the first user may not be able to access journal entries designated only for users who are Close or Very Close. In an embodiment, if a user accesses his own journal page or a specific journal entry, the social networking environment may permit the user to perform additional functions related to managing the journal and journal entries, such as, for example, editing or deleting the journal or journal entries.

Journal entries may be displayed, for example, in descending or ascending order based on the date that the entry was posted. In an embodiment, the subject of the journal entry, the author of the journal entry (in the case of group journals or newsletters), the text, photos, graphics and the like associated with the journal entry, and the date and time that the journal entry was posted, for example, may be displayed for each journal entry in the journal. The author of a journal entry may not be displayed if a user owns a journal instead of a group. If the journal owner permits comments to be added to journal entries, a designation of the number of comments and a link permitting a user to add comments to a journal entry, for example, may be associated with the journal entry.

In an embodiment, each journal entry has one or more links associated with the entry that the journal entry owner can access. In such an embodiment, only the journal owner may have access to these links. The links may include a link to edit a journal entry and a link to delete an entry.

The edit journal entry link may include one or more input fields, such as the subject of the journal entry, the content for the journal entry and a proximity threshold. A proximity threshold may be set, for example, by accessing a checklist or a pulldown menu to determine the relationship strength required to access a journal entry. Once the journal entry is complete, the owner may post the journal entry to a journal. The delete journal entry may remove the journal entry from a journal.

In an embodiment, a single user may keep multiple journals. In such an embodiment, the social networking environment may display a list of journals to a user. The journals may be organized alphabetically or in order of the most recently accessed journal.

Events

When a first user accesses a second user's calendar page within the social networking environment, the first user may be presented with events in the second user's calendar. The list of events may not include all events recorded by the second user due to a proximity threshold defined by the second user. For example, if the first user has a Distant relationship with the second user, the first user may not be able to access events designated only for users who are Close or Very Close. In an embodiment, if a user accesses his own journal page or a specific journal entry, the social networking environment may permit the user to perform additional functions related to managing the calendar and events, such as, for example, editing or deleting the calendar or events. If the owner of the calendar permits comments to be added to an event, a designation of the number of comments and a link permitting a user to add comments to an event, for example, may be associated with each event.

Events may be displayed, for example, in chronological order. In an embodiment, the date and time of the event, the title of the event, a link to event details, the host of the event (if the event is posted on a group calendar), and the location of the event, for example, may be displayed for each event in the calendar. The host of an event may not be displayed on a user's calendar because the host is known to be the user.

In an embodiment, the social networking environment displays events in a calendar format or a list format. In an embodiment, a first user viewing an event on a second user's calendar may click on a link to automatically add the event to the first user's calendar. In an embodiment, the birthdays of a user's contacts are automatically added to the user's calendar. In an embodiment, a guest list for an event is created using access control functionality. In such an embodiment, a user on the guest list may RSVP for an upcoming event.

In an embodiment, each event has one or more links associated with the entry that the calendar owner can access. In such an embodiment, only the calendar owner may have access to these links. The links may include a link to edit an event and a link to delete an event.

The edit event link may include one or more input fields, such as the date of the event, the time for the event, the title of the event, a description of the event, the venue for the event, a street address, a city, a state, a country, a zip code and a proximity threshold. A proximity threshold may be set, for example, by accessing a checklist or a pulldown menu to determine a relationship strength required to access an event. Once the event is complete, the owner may post the event to a calendar. The delete event may remove the event from a calendar.

Marketplace Items

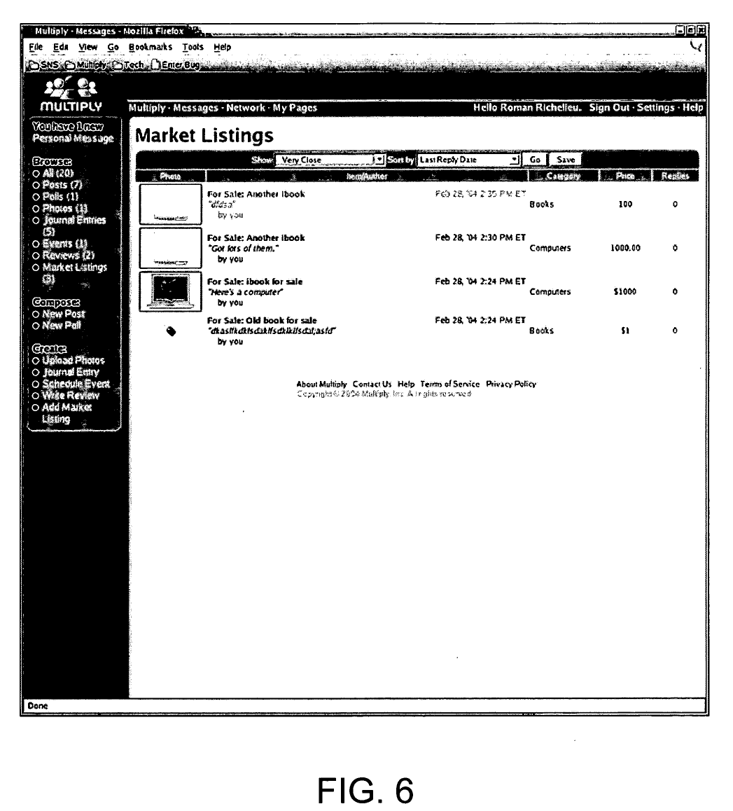

When a first user accesses a second user's marketplace page within the social networking environment, the first user may be presented with items listed by the second user. The item listings may not include all items listed by the second user due to a proximity threshold defined by the second user, such as is shown in FIG. 6. For example, if the first user has a Distant relationship with the second user, the first user may not be able to access marketplace items designated only for users who are Close or Very Close. In an embodiment, if a user accesses his own marketplace page or an item listing, the social networking environment may permit the user to perform additional functions related to managing the marketplace and the item listing, such as, for example, editing or deleting one or more listings. If the owner of the marketplace permits comments to be added to an item listing, a designation of the number of comments that have been made and a link permitting a user to add comments to an item listing, for example, may be associated with each item listing.

Item listings may be displayed, for example, in chronological order by the date that the item was listed. In an embodiment, a thumbnail of a photo associated with the item listing (if any), whether the user desires to sell or buy the listed item, a category for the listing, a title of the item, a price sought (in the case that the user is selling the listed item), and the date and time that the listing was posted, for example, may be displayed for each item listing in the marketplace.

In an embodiment, the social networking environment permits a user to spotlight one or more item listings to draw attention to featured items. In such an embodiment, the user may be required to have a predetermined number of listed items before the spotlighting feature is enabled.

In an embodiment, each item listing has one or more links associated with the listing that the marketplace owner can access. In such an embodiment, only the marketplace owner may have access to these links. The links may include a link to edit an item listing and a link to delete an item listing.

The edit item listing link may include one or more input fields, such as a buy/sell indicator, an item category, a title for the item listing, a description of the listed item, the price for the item, one or more photos depicting the listed item, and a proximity threshold. A proximity threshold may be set, for example, by accessing a checklist or a pulldown menu to determine the relationship strength required to access a marketplace item. Once the event is complete, the owner may post the item listing to the marketplace. The delete event may remove the item listing from the marketplace.

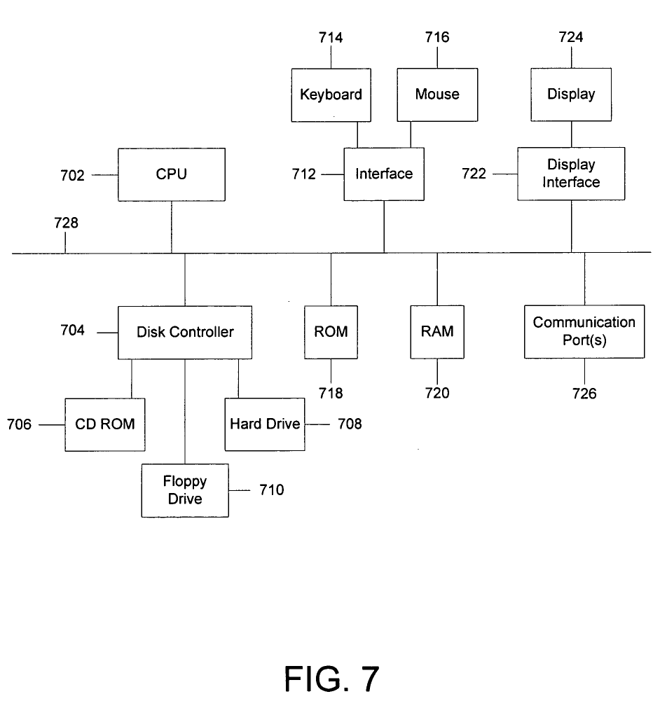

FIG. 7 is a block diagram of exemplary internal hardware that may be used to contain or implement the program instructions of a system embodiment of the present invention. Referring to FIG. 7, a bus 728 serves as the main information highway interconnecting the other illustrated components of the hardware. CPU 702 is the central processing unit of the system, performing calculations and logic operations required to execute a program. Read only memory (ROM) 718 and random access memory (RAM) 720 constitute exemplary memory devices.

A disk controller 704 interfaces with one or more optional disk drives to the system bus 728. These disk drives may be external or internal floppy disk drives such as 710, CD ROM drives 706, or external or internal hard drives 708. As indicated previously, these various disk drives and disk controllers are optional devices.

Program instructions may be stored in the ROM 718 and/or the RAM 720. Optionally, program instructions may be stored on a computer readable medium such as a floppy disk or a digital disk or other recording medium, a communications signal or a carrier wave.

An optional display interface 722 may permit information from the bus 728 to be displayed on the display 724 in audio, graphic or alphanumeric format. Communication with external devices may optionally occur using various communication ports 726. An exemplary communication port 726 may be attached to a communications network, such as the Internet or an intranet. A plurality of user computers may be attached to the communication port 726 via the communications network to provide user access to a social networking environment.

In addition to the standard computer-type components, the hardware may also include an interface 712 which allows for receipt of data from input devices such as a keyboard 714 or other input device 716 such as a remote control, pointer and/or joystick.

An embedded system may optionally be used to perform one, some or all of the operations of the present invention. Likewise, a multiprocessor system may optionally be used to perform one, some or all of the operations of the present invention.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method of generating a proximity index in a social networking environment, the method comprising:
determining one or more connections for a relationship between a first user of a social networking environment and a second user of the social networking environment;
determining a relationship strength for at least one of the one or more connections based on at least one relationship designator; and
determining a proximity index based on the one or more relationship strengths.

2. The method of claim 1 wherein the proximity index comprises a numerical value.

3. The method of claim 1 wherein determining a relationship strength is based on at least a number of tiers between the first user and the second user.

4. The method of claim 1 wherein determining a relationship strength is based on at least a relationship designator type.

5. The method of claim 1 wherein determining a relationship strength is based on at least the number of connections between the first user and the second user.

6. The method of claim 1 wherein determining a relationship strength is based on at least the first user being a first member of a group and the second user being a second member of the group.

7. The method of claim 6 wherein determining a relationship strength is based on at least a number of members of the group.

8. The method of claim 6 wherein determining a relationship strength is based on at least determining whether the group is one of a public group and a private group.

9. The method of claim 1 wherein determining a relationship strength is based on at least one or more communications between the first user and a second user.

10. The method of claim 9 wherein the one or more communications occur within the social networking environment.

11. The method of claim 1 wherein determining a relationship strength is based on at least one or more first communications between the first user and a third user and one or more second communications between the second user and a third user.

12. The method of claim 11 wherein the one or more first communications and the one or more second communications occur within the social networking environment.

13. The method of claim 1 wherein determining a relationship strength is based on at least one or more communications between a third user and a fourth user.

14. The method of claim 13 wherein the one or more communications occur within the social networking environment.

15. The method of claim 1, further comprising:
selecting a proximity index grouping for the connection from one or more proximity index groupings based on the proximity index.

16. The method of claim 15 wherein each proximity index grouping comprises relationships within a range of proximity indices.

17. The method of claim 15, further comprising:
permitting the second user to access content of the first user if the proximity index grouping for the second user's relationship with the first user corresponds to an access control value set by the first user.

18. The method of claim 15, further comprising:
preventing the second user from accessing content of the first user if the proximity index grouping for the second user's relationship with the first user does not correspond to an access control value set by the first user.

19. The method of claim 15, further comprising:
permitting the first user to access content directed to the first user by the second user if the proximity index grouping for the second user's relationship with the first user corresponds to an access control value set by the first user.

20. The method of claim 15, further comprising:
preventing the first user from accessing content directed to the first user by the second user if the proximity index grouping for the second user's relationship with the first user does not correspond to an access control value set by the first user.

21. The method of claim 1, further comprising:
permitting the second user to access content of the first user if the proximity index for the second user's relationship with the first user corresponds to an access control value set by the first user.

22. The method of claim 1, further comprising:
preventing the second user from accessing content of the first user if the proximity index for the second user's relationship with the first user does not correspond to an access control value set by the first user.

23. The method of claim 1, further comprising:
permitting the first user to access content directed to the first user by the second user if the proximity index for the second user's relationship with the first user corresponds to an access control value set by the first user.

24. The method of claim 1, further comprising:
preventing the first user from accessing content directed to the first user by the second user if the proximity index for the second user's relationship with the first user does not correspond to an access control value set by the first user.

25. A method of ordering a contact list in a social networking environment, the method comprising:
determining one or more proximity indices, wherein each proximity index is based on a strength of a relationship between a first user of a social networking environment and one of a plurality of second users of the social networking environment; and
ordering a social network for the first user based on the one or more proximity indices, wherein the social network for the first user comprises one or more second users.

26. The method of claim 25 wherein the social network for the first user only comprises second users having a proximity index exceeding a threshold.

27. The method of claim 25, further comprising:
displaying the ordered social network.

28. A method of ordering a contact list in a social networking environment, the method comprising:
determining one or more proximity indices, wherein each proximity index is based on a relationship strength between a first user of a social networking environment and one of a plurality of second users of the social networking environment;
determining a range of proximity indices for each of one or more proximity index groupings;
classifying each second user into at least one of one or more groups, wherein each group represents second users having a particular proximity index grouping; and
ordering a social network for the first user based on the groups, wherein the social network for the first user comprises one or more second users.

29. The method of claim 28 wherein the social network for the first user comprises only second users within one or more groups.

30. The method of claim 28, further comprising:
displaying the ordered social network.

31. The method of claim 30 wherein displaying the ordered social network comprises, for each group, displaying second users within the group alphabetically.

32. A system for generating a proximity index in a social networking environment, the system comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
determining one or more connections for a relationship between a first user of a social networking environment and a second user of the social networking environment,
determining a relationship strength for at least one of the one or more connections based on at least one relationship designator, and
determining a proximity index based on the one or more relationship strengths.

33. A system for generating a proximity index in a social networking environment, the system comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
determining one or more proximity indices, wherein each proximity index is based on a strength of a relationship between a first user of a social networking environment and one of a plurality of second users of the social networking environment, and
ordering a social network for the first user based on the one or more proximity indices, wherein the social network for the first user comprises one or more second users.

34. A system for generating a proximity index in a social networking environment, the system comprising:
a processor;
a computer-readable storage medium operably connected to the processor;
a communications network operably connected to the processor; and
a plurality of computer systems operably connected to the communications network,
wherein the computer-readable storage medium contains one or more programming instructions for performing a method of controlling access to content in a social networking environment, the method comprising:
determining one or more proximity indices, wherein each proximity index is based on a relationship strength between a first user of a social networking environment and one of a plurality of second users of the social networking environment,
determining a range of proximity indices for each of one or more proximity index groupings,
classifying each second user into at least one of one or more groups, wherein each group represents second users having a particular proximity index grouping, and
ordering a social network for the first user based on the groups, wherein the social network for the first user comprises one or more second users.
